(19) United States
(12) Patent Application Publication
(10) Pub. No.: US 2025/0197956 A1
(43) Pub. Date: Jun. 19, 2025

(54) METHOD AND SYSTEM FOR REMOVING CARBON DEPOSIT AT ELECTRIC HEATING SYSTEM IN A DIRECT REDUCTION PLANT UTILIZING HYDROGEN

(71) Applicant: Midrex Technologies, Inc., Charlotte, NC (US)

(72) Inventors: Haruyasu Michishita, Charlotte, NC (US); Taiji Hatakeyama, Kobe (JP)

(21) Appl. No.: 18/922,572

(22) Filed: Oct. 22, 2024

Related U.S. Application Data
(60) Provisional application No. 63/610,007, filed on Dec. 14, 2023.

(51) Int. Cl. C21B 13/02; C21B 13/00

(52) U.S. Cl. CPC C21B 13/026; C21B 13/0073; C21B 2100/26

(57) ABSTRACT

A direct reduction method and system including an electric heater system adapted to heat a reduction gas and a shaft furnace adapted to receive and utilize the heated reduction gas and one or more of a carbonaceous gas and/or material to produce the direct reduced iron containing carbon, including: providing the reduction gas to an electric heating elements of the electric heater system to heat the reduction gas; stopping the providing the reduction gas; and providing a hydrogen gas or a hydrogen gas with added steam to remove carbon deposition from the electric heating elements of the electric heater system while continuing to heat the reduction gas such that the direct reduced iron production including carbon is not interrupted.

### CROSS-REFERENCE TO RELATED APPLICATION

The present disclosure claims the benefit of priority of co-pending U.S. Provisional Patent Application No. 63/610,007, filed on Dec. 14, 2023, and entitled “METHOD AND SYSTEM FOR REMOVING CARBON DEPOSIT AT ELECTRIC HEATING SYSTEM IN A DIRECT REDUCTION PLANT UTILIZING HYDROGEN,” the contents of which are incorporated in full by reference.

### TECHNICAL FIELD

The present disclosure relates generally to the direct reduced iron (DRI) and steelmaking fields. More specifically, the present disclosure relates to an electric gas heating system for the reduction gas introduced into a shaft furnace to reduce iron oxide in a direct reduction plant utilizing hydrogen and/or natural gas.

### BACKGROUND

As part of global efforts to combat climate change, the steel sector seeks to reduce its CO2 emissions. In conventional steelmaking, the largest share of CO2 emissions originates during the reduction of iron ore, where iron oxide is reduced to metallic iron with coal in the case of a blast furnace and natural gas in the case of a direct reduction furnace. In the case of direct reduction, hydrogen produced from green sources can serve as a replacement for natural gas, greatly diminishing CO2 emissions during the reduction phase of steelmaking.

In state-of-art direct reduction processes with hydrogen close to 100%, to minimize CO2 emissions, an electric heater driven by the green electricity is applied to heat the reduction gas introduced into the shaft furnace to reduce the iron oxide, instead of a combustion heater fueled by the expensive hydrogen. In responding to the market demand to produce DRI containing carbon, a desirable property for downstream melting, some carbonaceous gas or material, such as natural gas, biogas, and/or biocarbon needs to be introduced into the shaft furnace or the reduction gas loop. However, the carbon tends to deposit on the electric heating elements because the recycled reduction gas fed to the electric heater has a higher carburizing potential with CO and other carbonaceous compounds. Likewise, in a state-of-art direct reduction process with natural gas or natural gas partially replaced by hydrogen to produce the DRI containing carbon, where methane in natural gas is reformed in the shaft furnace and no external reformer is required to produce H2 and CO for reducing the iron oxide, the electric heater instead of fuel gas combustion heater could be utilized to heat the reduction gas to reduce CO2 emission. Then, the carbon may also deposit on the electric heater elements because the reduction gas has a higher carburizing potential as well. This carbon deposition may cause overheating or damage the electric heater unless the electric heater conducts a carbon burnout with the oxidized gas from time to time. Then, the plant must be idle to remove the material of the shaft furnace and production must be stopped since the oxidized gas oxidizes the material and causes clustering in the shaft furnace.

Accordingly, there is a need for improved methods and systems to burnout the carbon deposited on the electric heating elements when DRI containing carbon is produced in a direct reduction plant with the electric heater utilizing hydrogen and/or natural gas to minimize CO2 emissions.

### BRIEF SUMMARY

Embodiments of the present disclosure address the foregoing needs and others. Embodiments of the present disclosure improve upon prior methods and systems of producing DRI containing carbon and minimizing CO2 emissions. For instance, it has been determined that an electric gas heater using the green electricity derived from renewable energy, which is also used to produce green hydrogen with electrolysis, can be used to reduce CO2 emissions.

According to embodiments, disclosed is a method and system to produce DRI containing carbon utilizing hydrogen including a direct reduction shaft furnace adapted to reduce iron oxide to metallic iron with hydrogen rich reduction gas, where carbonaceous gas and/or carbonaceous solid material is introduced into the direct reduction shaft furnace to produce the DRI containing carbon, where make-up hydrogen is added to the recycled shaft furnace effluent gas, and thereafter the recycled hydrogen rich reduction gas is heated with an electric gas heating system, where the recycled hydrogen rich reduction gas contains CO, CO2, and other carbonaceous compounds which may cause the carbon deposition on the heating element of the electric heater. The deposited carbon is removed by eliminating the carbonaceous compounds in the recycled hydrogen rich gas fed to the electric gas heating system, which is achieved by turning off the carbonaceous gas addition into the direct reduction shaft furnace or stopping the feeding of the solid carbon material, such as biocarbon, with the iron oxide feedstock to produce DRI containing zero carbon. After removing the carbon deposited in the electric heater, the carbonaceous gas introduced into the shaft furnace is turned back on or feeding the recycled hydrogen rich gas containing CO, CO2, and other carbonaceous compounds is resumed to again produce DRI containing carbon.

Also, according to embodiments, disclosed is a method and system to produce DRI containing carbon utilizing hydrogen or natural gas including a direct reduction shaft furnace adapted to reduce iron oxide to metallic iron with the reduction gas, where carbonaceous gas and/or carbonaceous solid material is introduced into the direct reduction shaft furnace to produce the DRI containing carbon, where make-up hydrogen and/or natural gas is added to the recycled shaft furnace effluent gas, and thereafter the recycled mixed gas comprising H2, H2O, CO, CO2, N2, and other carbonaceous compounds is heated with an electric gas heating system. Carbon deposited on the heating element of the electric heater is removed by introducing a part of make-up hydrogen instead of the recycled mixed gas to a partial block of the electric heating system to remove the carbon deposition. After removing the carbon deposit on the electric heating element in the first partial block of the electric heating system, the introduction of the make-up hydrogen is switched from the first partial block to a second partial block and the introduction of the recycled mixed gas is restored in the first partial block. The switching back and forth between the make-up hydrogen and the recycled mixed gas introduced into a third and other blocks will follow until the carbon is removed on all the heating elements in the electric heating system while the plant continues to produce the DRI containing carbon.

Further, according to embodiments, disclosed is a method and system to produce DRI containing carbon utilizing hydrogen or natural gas including a direct reduction shaft furnace adapted to reduce iron oxide to metallic iron with the reduction gas, where carbonaceous gas and/or carbonaceous solid material is introduced into the direct reduction shaft furnace to produce the DRI containing carbon, where make-up hydrogen and/or natural gas is added to the recycled shaft furnace effluent gas, and thereafter the recycled mixed gas comprising H2, H2O, CO, CO2, N2, and other carbonaceous compounds is heated with an electric gas heating system CO2. Carbon deposited on the heating element of the electric heater is removed by introducing a part of make-up hydrogen mixed with a small amount of steam instead of the recycled mixed gas to a partial block of the electric heating system to remove the carbon deposition. The steam is added to the part of the make-up hydrogen with a saturator to which steam or sprayed water is injected. After removing the carbon deposit on the electric heating element in the first partial block of the electric heating system, the introduction of the make-up hydrogen with the steam is switched from the first partial block to a second partial block and the introduction of the recycled mixed gas is restored in the first partial block. The switching back and forth between the make-up hydrogen with the steam and the recycled mixed gas introduced into a third partial block and other blocks will follow until the carbon is removed on all the heating elements in the electric heating system while the plant continues to produce the DRI containing carbon.

In some embodiments, the offgas temperature from the electric gas heating unit, while the carbon deposits on the electric heating element is being removed with the hydrogen, is higher than about 850° C., more preferably around 1000° C.

In some embodiments, the present disclosure provides a method for operating a direct reduction system including an electric heater system adapted to heat a reduction gas of a higher carburizing potential with CO and other carbonaceous compounds and a shaft furnace adapted to receive and utilize the heated reduction gas to reduce the iron oxide and one or more of a carbonaceous gas and a carbonaceous material to carburize the reduced iron oxide, the method including: providing the reduction gas of a higher carburizing potential to an electric heating element of a first block of the electric heater system and an electric heating element of a second block of the electric heater system to heat the reduction gas using the electric heating element of the first block of the electric heater system and the electric heating element of the second block of the electric heater system; stopping the providing the reduction gas to the electric heating element of the first block of the electric heater system; and providing a hydrogen gas or hydrogen gas with added steam to the electric heating element of the first block of the electric heater system to remove carbon deposition from the electric heating element of the first block of the electric heater system while continuing to heat the reduction gas using the electric heating element of the second block of the electric heater system such that the production of direct reduced iron containing carbon in the shaft furnace is not interrupted.

In some embodiments, the method further includes: stopping the providing the hydrogen gas or the hydrogen gas with added steam to the electric heating element of the first block of the electric heater system when the carbon deposition is removed from the electric heating element of the first block of the electric heater system; and resuming the providing the reduction gas of a higher carburizing potential to the electric heating element of the first block of the electric heater system to again heat the reduction gas using the electric heating element of the first block of the electric heater system.

In some embodiments, each of the first block of the electric heater system and the second block of the electric heater system utilizes a direct heating mechanism incorporating the associated electric heating element.

In some embodiments, CO2 the hydrogen gas includes make-up hydrogen gas that is also used to form the hydrogen rich reducing gas, and/or the hydrogen gas with added steam is formed in a saturator. The saturator is adapted to add the steam to make-up hydrogen gas that is also used to form the hydrogen rich reducing gas. The hydrogen dedicated to remove the carbon deposition in the electric heater system could be used in case no make-up hydrogen is added to the recycled reduction gas.

In some embodiments, the reduction gas includes top gas recycled from the shaft furnace.

In some embodiments, the present disclosure provides a direct reduction system including: an electric heater system adapted to heat a reduction gas; a shaft furnace adapted to receive and utilize the reduction gas to reduce the iron oxide and one or more of a carbonaceous gas and a carbonaceous material to carburize the reduced iron oxide to produce direct reduced iron containing carbon; first and second valves for providing the reduction gas to an electric heating element of a first block of the electric heater system and an electric heating element of a second block of the electric heater system to heat the reduction gas using the electric heating element of the first block of the electric heater system and the electric heating element of the second block of the electric heater system; the first valve for stopping the providing the reduction gas to the electric heating element of the first block of the electric heater system; and a third valve for providing a hydrogen gas or hydrogen gas with added steam to the electric heating element of the first block of the electric heater system to remove carbon deposition from the electric heating element of the first block of the electric heater system while continuing to heat the hydrogen rich reducing gas using the electric heating element of the second block of the electric heater system such that the reducing the iron oxide to the direct reduced iron including carbon in the shaft furnace is not interrupted.

In some embodiments, the direct reduction system further includes: the third valve for stopping the providing the hydrogen gas or the hydrogen gas with added steam to the electric heating element of the first block of the electric heater system when the carbon deposition is removed from the electric heating element of the first block of the electric heater system; and the first valve for resuming providing the reduction gas to the electric heating element of the first block of the electric heater system to again heat the reduction gas using the electric heating element of the first block of the electric heater system.

In some embodiments, each of the first block of the electric heater system and the second block of the electric heater system utilizes a direct heating mechanism incorporating the associated electric heating element.

In some embodiments, CO2 the hydrogen gas includes make-up hydrogen gas that is also used to form the hydrogen rich reducing gas, and/or the hydrogen gas with added steam is formed in a saturator. The saturator is adapted to add the steam to make-up hydrogen gas that is also used to form the hydrogen rich reducing gas. The hydrogen dedicated to remove the carbon deposition in the electric heater system could be used in case no make-up hydrogen is added to the recycled reduction gas.

In some embodiments, the hydrogen rich reduction gas includes top gas recycled from the shaft furnace.

In some embodiments, the present disclosure provides a method for operating a direct reduction system including an electric heater system adapted to heat a hydrogen rich reduction gas including top gas recycled from a shaft furnace and the shaft furnace adapted to receive and utilize the heated hydrogen rich reduction gas to reduce iron oxide to direct reduced iron, the method including: providing the hydrogen rich reduction gas to at least one electric heating element of the electric heater system to heat the hydrogen rich reduction gas; introducing one or more of a carbonaceous gas and a carbonaceous material to an interior of the shaft furnace to carburize the reduced iron oxide and reducing the iron oxide using the heated hydrogen rich reduction gas in the presence of the one or more of the carbonaceous gas and the carbonaceous material to produce direct reduced iron containing carbon; stopping the introducing the one or more of the carbonaceous gas and the carbonaceous material to the interior of the shaft furnace and the reducing the iron oxide using the heated hydrogen rich reducing gas in the presence of the one or more of the carbonaceous gas and the carbonaceous material; reducing the iron oxide using only the heated hydrogen rich reduction gas to produce direct reduced iron not containing carbon to remove carbon deposition from the at least one electric heating element of the electric heater system; and again introducing one or more of the carbonaceous gas and the carbonaceous material to the interior of the shaft furnace and again reducing the iron oxide using the heated hydrogen rich reduction gas in the presence of the one or more of the carbonaceous gas and the carbonaceous material to produce direct reduced iron containing carbon.

In some embodiments, the electric heater system utilizes a direct heating mechanism incorporating the at least one electric heating element.

In some embodiments, the hydrogen rich reducing gas includes the top gas recycled from a shaft furnace and make-up hydrogen derived from an external source.

It will be readily apparent to those of ordinary skill in the art that elements, limitations, aspects, and characteristics of the various embodiments of the present disclosure may be included, omitted, and combined as desired in a given application, without limitation.

### BRIEF DESCRIPTION OF THE DRAWINGS

The present disclosure is illustrated and described with reference to the various drawings, in which like reference numbers are used to denote like system/assembly components and/or method steps, as appropriate, and in which:

FIG. 1 is a schematic diagram illustrating a prior direct reduction system utilizing make-up hydrogen and/or natural gas with an electric heating system, where carbonaceous gas is introduced into the shaft furnace to produce DRI containing carbon, and where, to burnout carbon deposited on the electric heating element, oxidized gas instead of reduction gas is fed to the electric heater from time to time, when the plant is in idling and production is stopped;

FIG. 2 (FIGS. 2-1 and 2-2) is a schematic diagram illustrating another prior direct reduction system utilizing make-up hydrogen and/or natural gas with an electric heating system, where carbonaceous gas is introduced into the shaft furnace to produce DRI containing carbon, and where oxidized gas instead of reduction gas is fed to a partial block of the electric heating elements to burnout carbon deposited on the electric heating elements one by one while the plant continues producing DRI containing carbon utilizing other blocks of the electric heating elements with reduction gas;

FIG. 3 is a schematic diagram illustrating a further direct reduction system utilizing make-up hydrogen with an electric heating system, where carbonaceous gas to the shaft furnace is stopped for the system to produce DRI containing no carbon after carbon deposits on the electric heating element, where the hydrogen rich gas containing no carbonaceous compounds is fed to electric heater to remove the carbon deposit, and thereafter the carbonaceous gas to the shaft furnace is resumed to produce DRI containing carbon;

FIG. 4 (FIGS. 4-1 and 4-2) is a schematic diagram illustrating another direct reduction system utilizing make-up hydrogen and/or natural gas with an electric heating system, where carbonaceous gas is introduced into the shaft furnace to produce DRI containing carbon, and where hydrogen is fed to a partial block of the electric heating elements to burnout carbon deposited on the electric heating elements one by one while the plant continues producing DRI containing carbon utilizing other blocks of the electric heating elements with reduction gas; and

FIG. 5 (FIGS. 5-1 and 5-2) is a schematic diagram illustrating another direct reduction system utilizing make-up hydrogen and/or natural gas with an electric heating system, where carbonaceous gas is introduced into the shaft furnace to produce DRI containing carbon, and where hydrogen and a small amount of steam added via a saturator is fed to a partial block of the electric heating elements to burnout carbon deposited on the electric heating elements one by one while the plant continues producing DRI containing carbon utilizing other blocks of the electric heating elements with reduction gas.

It will be readily apparent to those of ordinary skill in the art that elements, limitations, aspects, and characteristics of the various drawings of the present disclosure may be included, omitted, and combined as desired in a given application, without limitation.

### DETAILED DESCRIPTION

Again, in various embodiments, the present disclosure advantageously provides an efficient reduction gas heating system with the higher operability in a direct reduction plant utilizing hydrogen close to 100% and/or natural gas to produce DRI containing carbon. In the direct reduction plant utilizing hydrogen close to 100%, an electric gas heater may use electricity derived from renewable energy, which is also used to produce green hydrogen with electrolysis, and is used to reduce CO2 emissions.

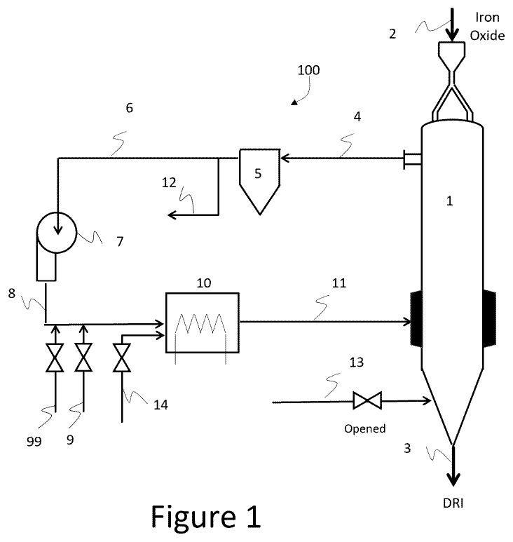

FIG. 1 shows a prior direct reduction system utilizing hydrogen close to 100% when make-up H2 9 applied, a prior direct reduction system/method using natural gas when make-up natural gas 99 is applied, or a prior natural gas/hydrogen reduction system/method using natural gas partially replaced by hydrogen when both make-up hydrogen 9 and make-up natural gas 99 is applied. The shaft furnace 1 receives iron oxide 2 at the top and discharges product DRI 3 from the bottom after direct reduction of the iron oxide 2 in the presence of reducing gas 11 within the shaft furnace 1. Shaft furnace top gas 4, which is the spent gas after the reduction of the iron oxide 2 and containing reaction products such as H2O and CO2 as well as unused reductant such as H2, CO, and CH₄, is recirculated through the reduction gas loop 100. After the top gas 4 is cooled and cleaned with the scrubber 5, most of the cleaned gas 6 is recycled to the shaft furnace 1 since it still contains H2 and CO, while what is called the top gas fuel 12 is partially removed to prevent the accumulation of inert N2 and CO2 in the reduction gas loop 100. In case of the direct reduction with hydrogen close to 100%, make-up H2 9 is added to the pressurized cleaned gas 8 after the compressor 7. In case of the direct reduction with natural gas, make-up natural gas 99 is added to the pressurized cleaned gas 8 after compression 7, wherein methane in the natural gas is reformed catalytically with the direct reduction iron to produce H2 and CO to reduce the iron oxide simultaneously in the shaft furnace. After the addition of make-up hydrogen 9 and/or natural gas 99, the mixed gas is fed to the electric heating system 10, which is a gas heating unit using a direct heating mechanism to heat the cold mixed gas to the higher temperature (900˜1100° C.) required for the iron oxide reaction in the shaft furnace 1.

With the hydrogen reduction case to minimize CO2 emission, in response to market demand to produce DRI 3 containing carbon, a desirable property for downstream melting, carburizing gas 13, which is carbonaceous gas such as natural gas, biogas, and/or the product gas from biocarbon gasification, may be introduced into the lower part of the shaft furnace 1 to carburize the material after being reduced in the upper part of the shaft furnace 1. Furthermore, biocarbon material could be fed with the iron oxide 2 to the shaft furnace 1 to produce the DRI 3 containing carbon.

In such cases, the introduced carbon agent carburizes the DRI 3 but partially slips to form CO, CO2, and CH4 in the shaft furnace 1. These carbonaceous gas compounds are discharged together with the H2, H2O, and N2 in the top gas 4 and eventually recycled to the electric heating system 10. The carbon tends to deposit on the electric heating elements when the higher carburizing potential with CO contained in the recycled gas is heated up to above 600° C., more specifically in the temperature range from 600 to 800° C. This carbon deposition may cause carbon buildup or carbon corrosion (metal dusting) on/of the electric heating elements and deteriorate the heating performance or shorten the life of the electric heating elements in the case that the gas is heated with the direct heating mechanism. The carbon deposition may damage the electric heating elements due to the overheating of the electric heating elements covered with carbon. Further, the gas passages around the electric heating elements may be plugged when the carbon deposition grows. Typically, the direct heating mechanism is applied to heat the process gas to the higher temperature (900˜1100° C.) because direct heating with the elements heating elements achieves higher heat transfer and/or minimizes the element operation temperature given the small approach temperature to extend the element life.

With the natural gas reduction case reforming methane to produce H2 and CO to reduce the iron oxide simultaneously in the shaft furnace, the recycled gas 4,6,8 having even higher carburizing potential is eventually recycled to the electric heating system 10, where the carbon tends to deposit on the electric heating elements of the electric heating system 10. In addition to CO contained in the recycled gas mentioned in the above hydrogen reduction case, CH4 also tends to crack and deposit on the electric heating elements since CH4 content in the recycled mixed gas increases after the addition of make-up natural gas 99.

The carbon deposition in the electric heating system 10 can be burned out by introducing oxidized gas 14 into the electric heating system 10. Chemical reactions for the carbon burnout with various oxidized gases are shown below in Equations 1-3. All of these are exothermic reactions.

C+H₂O→CO+H₂+131.3 KJ/mole Equation 1

C+CO₂→2CO+172.5 KJ/mole Equation 2

C+O₂→CO₂+393.5 KJ/mole Equation 3

However, these oxidized gases 14, such as H2O, CO2, and O2 cannot be introduced on-line or during the normal production period since this would oxidize the DRI 3 and cause clustering in the shaft furnace 1. Therefore, the burn out process with the oxidized gas 14 generally must take place off-line or during an idling period without the DRI 3 retained in the shaft furnace 1. This prevents plant availability when the carbon burnout is executed to manage the carbon deposition from time to time.

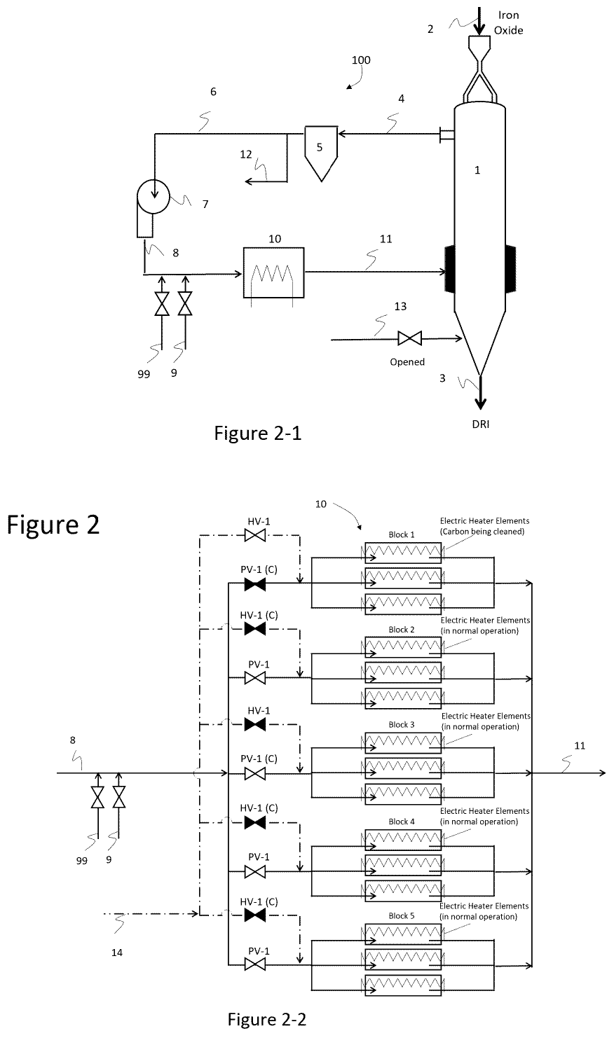

FIG. 2 (FIGS. 2-1 and 2-2) shows another prior direct reduction system utilizing make-up H2 9 and/or natural gas 99, which burns out the carbon deposition in the electric heating system 10 while the plant is running and continuing DRI production. The oxidized gas 14 is introduced only to a partial block of the electric heating system 10 (only Block 1 in FIG. 2-2) to burn out the carbon deposition in the partial block while the recycled mixed gas (the gas mixture 8,9, and/or 99) containing the carbonaceous compounds is introduced to the other blocks as normal (Blocks 2˜5 in FIG. 2-2). This is accomplished by the selective closing of valve PV-1 to Block 1 to stop the recycled mixed gas flow, with valves PV-1 open for Blocks 2-5 to maintain the recycled mixed gas flow. Valve HV-1 is open to Block 1 to provide the oxidized gas flow for the carbon burn out in Block 1, while valves HV-1 are closed to Blocks 2-5 to prevent the oxidized gas flow to Blocks 2-5. It should be noted that each block may have multiple electric heating elements. After removing the carbon deposit on the electric heating elements in Block 1, the introduction of the oxidized gas 14 is switched from Block 1 to Block 2 (and so on) and the recycled mixed gas containing the carbonaceous compounds is resumed to Block 1 (and so on). In this manner, the plant can continue to reduce the iron oxide 2 and produce the DRI 3 containing carbon. However, the oxidized gas discharged from the electric heater system 10 (Block 1 in FIG. 2-2) after burning out the carbon deposition reduces the reduction potential of the hot reduction gas 11, which accordingly leads to the productivity drop or product quality deterioration. This system requires the additional oxidized gas source 14. Steam or oxygen may be purchased with additional cost, but causes some issues mentioned below. CO2 is not generally available at reasonable cost or under ordinary logistics arrangements.

Steam tends to cause water condensation at the inlet of the electric heater 10, especially during initial start-up, which may cause issues in the electric heating elements including metallic wires. Oxygen may heat up or oxidize the electric heating elements too much around the carbon deposition, which may lead to the damage of the electric heating elements. The reaction with oxygen makes the most reaction heat as shown in the above Equation 3, which may make it difficult to reasonably control the temperature.

Thus, an advantage of some embodiments of the present disclosure is to apply the chemical reaction shown below, where the reducing gas (H2) 9 instead of the oxidized gas 14 is used to remove the carbon deposited on the electric heating elements. A series of tests have been done to verify that hydrogen can remove the carbon deposition on the electric heating elements effectively under given conditions.

C+2H₂→CH₄+74.8 KJ/mole Equation 4

Hydrogen 9 is thus fed to the electric heater system 10 to remove the carbon on the electric heating elements and produce CH₄ and does not lower the reduction potential of the hot reduction gas 11, unlike the case with the oxidizing gas 14. Accordingly, the carbon removal can be done on-line while the direct reduction plant continues to produce the DRI 3, maintaining the productivity and product quality. Also, as shown above, the exothermic chemical reaction heat with Equation 4 is lower than those with Equations 1-3 with the oxidized gas 14. This makes it easier to control the temperature to prevent the electric heating elements from being overheated and causing damage.

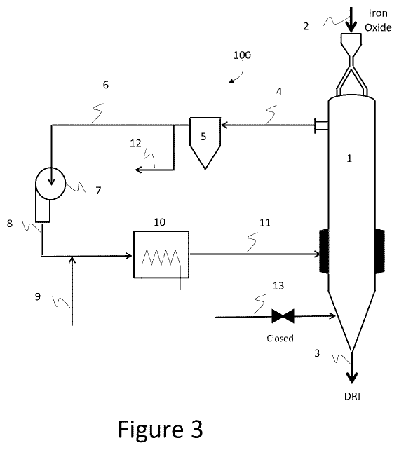

In the embodiment shown in FIG. 3, DRI 3 containing zero carbon is produced without introducing the carbonaceous gas 13 into the lower part of the shaft furnace 1, as no carbonaceous compounds are discharged from the shaft furnace 1. Adding the make-up H2 9 to the pressurized cleaned gas 8 containing no carbonaceous compounds, the recycled mixed gas to the electric heating system 10, which is H2 rich gas containing H2>80% with no carbonaceous gas compounds, effectively removes the carbon deposits on the electric heating elements according to the above Equation 4, the accumulation of which was made while the direct reduction plant was producing the DRI 3 containing carbon with the carbonaceous gas 13 fed into the lower part of the shaft furnace 1. The offgas temperature from the electric gas heating unit, while the carbon deposits on the electric heating element is being removed with the hydrogen, is higher than about 850° C., more preferably around 1000° C. Comparing with the carbon removal operation complicated with on-and-off introduction of the oxidized gas 14 shown in FIGS. 1 and 2, the carbon removal operation with the continuous make-up H2 introduction shown in FIG. 3 is simpler. In other words, from time to time or when the carbon deposition develops on the electric heating elements, it can be removed by shifting production from DRI 3 containing carbon to the DRI 3 containing zero carbon by turning off the carbonaceous gas addition 13 into the shaft furnace 1 or stopping feeding solid carbon material such as biocarbon with the iron oxide feedstock if applied. After removing the carbon deposits on the electric heating elements though this operation, the carbonaceous gas addition 13 into the shaft furnace 1 or feeding the solid carbon material may be resumed to produce DRI 3 containing carbon.

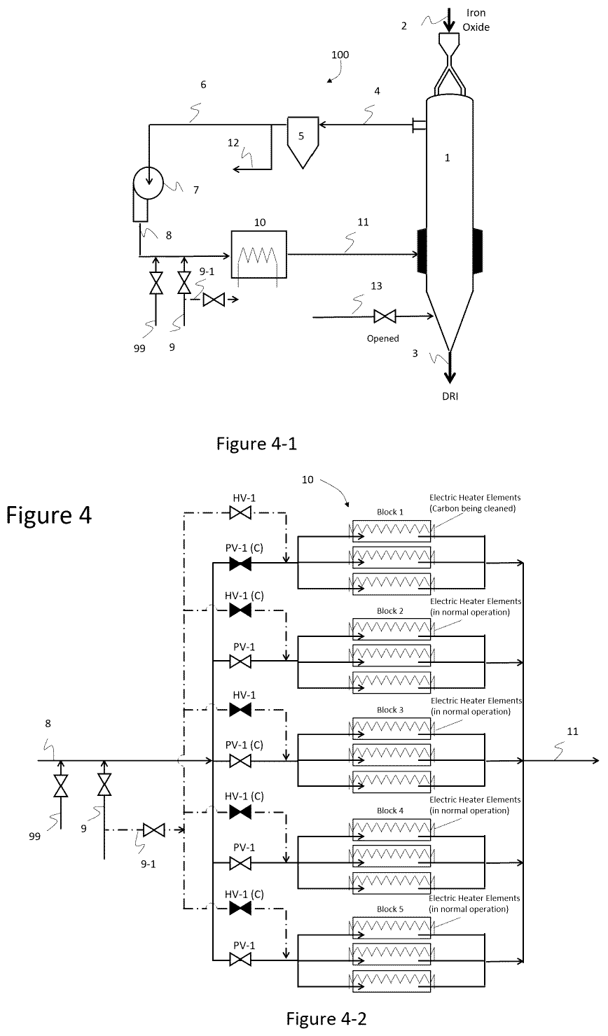

In another embodiment shown in FIG. 4 (FIGS. 4-1 and 4-2) for a direct reduction system utilizing make-up H2 9 and/or natural gas 99, which removes carbon deposition in the electric heating system 10 while the plant is running and continue to produce DRI 3 containing carbon with the carbonaceous gas 13 introduced into the shaft furnace 1, the top gas 4 and the recycled reduction gas 8 to the electric heater 10 contains the carbonaceous compounds which causes carbon deposition on the electric heating elements. Like in FIG. 2, the idea is to introduce a part of the make-up H2 9-1 to a partial block of the electric heater system 10 (only Block 1 in FIG. 4-2) to remove the carbon deposition according to the above Equation 4. The offgas temperature from the electric gas heating unit, while the carbon deposits on the electric heating element is being removed with the hydrogen, is higher than about 850° C., more preferably around 1000° C. After removing the carbon deposition on the electric heating element in Block 1, the introduction of the make-up H2 9-1 is switched from Block 1 to Block 2 (and so on) and the introduction of the recycled H2 reduction gas (the gas mixture 8,9 and/or 99) is resumed to Block 1 (and so on). The switching back and forth between the make-up hydrogen 9-1 and the recycled reduction gas 8 introduced into Block 3 and other blocks will follow until the carbon is removed on all the heating elements in the electric heating system while the plant continues to produce the DRI containing carbon. In this manner, the plant can continue to reduce the iron oxide 2 and produce the DRI 3 containing carbon even as carbon depositions are sequentially removed. The total amount of the make-up H2 9 can remain the same since H2 and CH₄ discharged from the electric heater Block 1 or other Blocks after removing the carbon deposition does not lower the reduction potential of the hot reduction gas 11. Unlike FIG. 2, this system does not require the additional oxidized gas source 14. Due to the lower exothermic reaction heat per Equation 4, the temperature around the electric heating elements can be easily controlled to prevent the electric heating elements from being overheated during the carbon removal process.

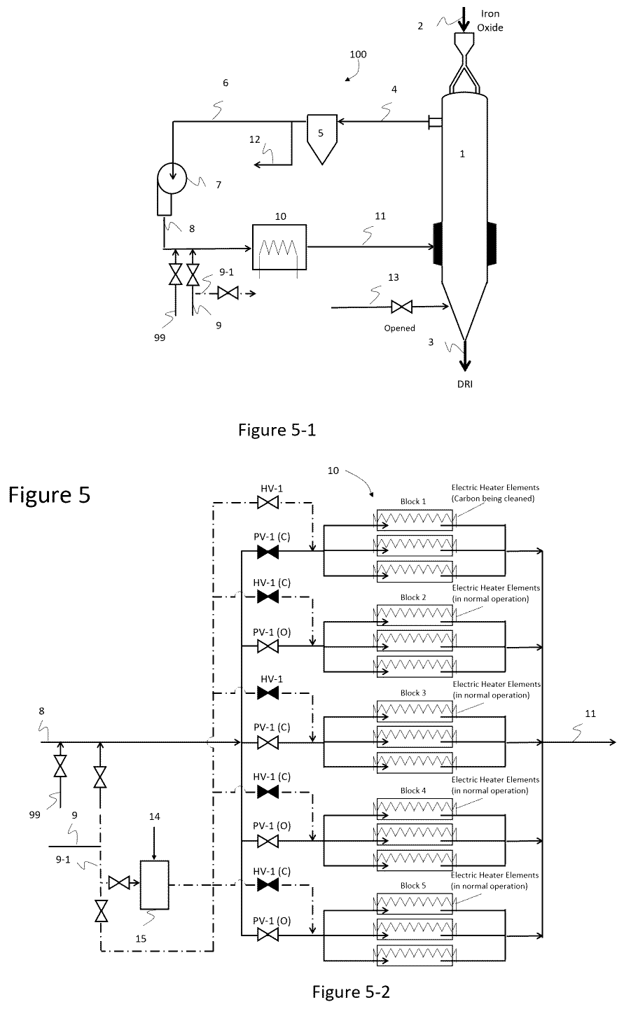

In another embodiment shown in FIG. 5 (FIGS. 5-1 and 5-2) for a direct reduction system utilizing make-up H2 9 and/or natural gas 99, which removes carbon deposition in the electric heating system 10 while the plant is running and continue to produce DRI 3 containing carbon with the carbonaceous gas 13 introduced into the shaft furnace 1, the top gas 4 and the recycled reduction gas 8 to the electric heater 10 contains the carbonaceous compounds which causes carbon deposition on the electric heating elements. The idea is to introduce a part of make-up H2 9-1 as in FIG. 4 together with a small amount of steam to the partial block of the electric heater system 10 (only Block 1 in FIG. 5-2) to remove the carbon deposition according to the above Equations 1 and 4. Thus, this is essentially the scheme of FIG. 4 with steam addition. The limited amount of steam can be added to let the part of the make-up H2 9-1 go through the saturator 15 to which steam or sprayed water 14 are injected. Even a small amount of steam added in the gas introduced to the Block 1, such as H2O mole fraction <5%, significantly enhances the carbon removal performance, so that the period required for carbon removal can be shortened. By limiting the amount of steam addition or controlling the dew point, the downstream water condensation can be prevented. Like the scheme of FIG. 4, after removing the carbon deposition on the electric heating elements in Block 1, the introduction of the make-up H29-1 mixed with the steam 14 is switched from Block 1 to Block 2 (and so on) and the introduction of the recycled reduction gas (the gas mixture of 8,9 and/or 99 is resumed for Block 1 (and so on). The switching back and forth between the make-up hydrogen with the steam and the recycled mixed gas introduced into Block 3 and other blocks will follow until the carbon is removed on all the heating elements in the electric heating system while the plant continues to produce the DRI containing carbon. In this manner, the plant can continue to reduce the iron oxide 2 and produce the DRI 3 containing carbon even as carbon depositions are sequentially removed. Additional steam addition to the make-up H2 9-1 lowers the reduction potential of the hot reduction gas 11, but this effect is minimal. The benefit of the shorter period required for carbon removal outweighs any disadvantages.

Although the present disclosure is illustrated and described with reference to particular embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims for all purposes. Moreover, all features, elements, and embodiments described may be used in any combination, without limitation.

What is claimed is:

1. A method for operating a direct reduction system comprising an electric heater system adapted to heat a reduction gas and a shaft furnace adapted to receive and utilize the heated reduction gas to reduce iron oxide and one or more of a carbonaceous gas and/or a carbonaceous material to carburize the reduced iron oxide to produce the direct reduced iron containing carbon, the method comprising:
providing the reduction gas to an electric heating element of a first block of the electric heater system and an electric heating element of a second block of the electric heater system to heat the reduction gas using the electric heating element of the first block of the electric heater system and the electric heating element of the second block of the electric heater system;
stopping the providing the reduction gas to the electric heating element of the first block of the electric heater system; and
providing a hydrogen gas or a hydrogen gas with added steam to the electric heating element of the first block of the electric heater system to remove carbon deposition from the electric heating element of the first block of the electric heater system while continuing to heat the reduction gas using the electric heating element of the second block of the electric heater system such that the production of the direct reduced iron containing carbon with the shaft furnace is not interrupted.

2. The method of claim 1, further comprising:
stopping the providing the hydrogen gas or the hydrogen gas with added steam to the electric heating element of the first block of the electric heater system when the carbon deposition is removed from the electric heating element of the first block of the electric heater system; and
resuming the providing the reduction gas to the electric heating element of the first block of the electric heater system to again heat the reduction gas using the electric heating element of the first block of the electric heater system.

3. The method of claim 1, wherein the offgas temperature from the electric gas heating unit is higher than 850° C., while the carbon deposits on the electric heating element is removed with the hydrogen.

4. The method of claim 1, wherein the offgas temperature from the electric gas heating unit is higher than 1000° C., while the carbon deposits on the electric heating element is removed with the hydrogen.

5. The method of claim 1, wherein each of the first block of the electric heater system, the second block of the electric heater system, and other blocks of the electric heater system utilizes a direct heating mechanism incorporating the associated electric heating element.

6. The method of claim 1, wherein the hydrogen gas comprises make-up hydrogen gas that is also used to form the reduction gas.

7. The method of claim 1, wherein the hydrogen gas with added steam is formed in a saturator.

8. The method of claim 7, wherein the saturator is adapted to add the steam to make-up hydrogen gas that is also used to form the reduction gas.

9. The method of claim 1, wherein the reduction gas comprises top gas recycled from the shaft furnace and make-up hydrogen and/or natural gas.

10. A direct reduction system comprising:
an electric heater system adapted to heat a reduction gas;
a shaft furnace adapted to receive and utilize the heated reduction gas to reduce iron oxide and one or more of a carbonaceous gas and/or a carbonaceous material to carburize the reduced iron oxide to produce the direct reduced iron containing carbon;
first and second valves for providing the reduction gas to an electric heating element of a first block of the electric heater system and an electric heating element of a second block of the electric heater system to heat the reduction gas using the electric heating element of the first block of the electric heater system and the electric heating element of the second block of the electric heater system;
the first valve for stopping the providing the reduction gas to the electric heating element of the first block of the electric heater system; and
a third valve for providing a hydrogen gas or a hydrogen gas with added steam to the electric heating element of the first block of the electric heater system to remove carbon deposition from the electric heating element of the first block of the electric heater system while continuing to heat the reduction gas using the electric heating element of the second block of the electric heater system such that the production of the direct reduced iron containing carbon with the shaft furnace is not interrupted.

11. The direct reduction system of claim 10, further comprising:
the third valve for stopping the providing the hydrogen gas or the hydrogen gas with added steam to the electric heating element of the first block of the electric heater system when the carbon deposition is removed from the electric heating element of the first block of the electric heater system; and
the first valve for resuming the providing the reduction gas to the electric heating element of the first block of the electric heater system to again heat the reduction gas using the electric heating element of the first block of the electric heater system.

12. The direct reduction system of claim 10, wherein each of the first block of the electric heater system and the second block of the electric heater system utilizes a direct heating mechanism incorporating the associated electric heating element.

13. The direct reduction system of claim 10, wherein the hydrogen gas comprises make-up hydrogen gas that is also used to form the reduction gas.

14. The direct reduction system of claim 10, wherein the hydrogen gas with added steam is formed in a saturator.

15. The direct reduction system of claim 14, wherein the saturator is adapted to add the steam to make-up hydrogen gas that is also used to form the reduction gas.

16. The direct reduction system of claim 10, wherein the reduction gas comprises top gas recycled from the shaft furnace and make-up hydrogen and/or natural gas.

17. A method for operating a direct reduction system comprising an electric heater system adapted to heat a hydrogen rich reduction gas comprising top gas recycled from a shaft furnace and the shaft furnace adapted to receive and utilize the heated hydrogen rich reducing gas to reduce iron oxide to produce the direct reduced iron, the method comprising:
providing the hydrogen rich reducing gas to at least one electric heating element of the electric heater system to heat the hydrogen rich reducing gas;
introducing one or more of a carbonaceous gas and/or a carbonaceous material to an interior of the shaft furnace to carburize the reduced iron oxide;
using the heated hydrogen rich reducing gas in the presence of the one or more of the carbonaceous gas and/or the carbonaceous material to produce the direct reduced iron containing carbon;
stopping the introducing the one or more of the carbonaceous gas and the carbonaceous material to the interior of the shaft furnace;
reducing the iron oxide using only the heated hydrogen rich reducing gas to produce the direct reduced iron not containing carbon to remove carbon deposition from the at least one electric heating element of the electric heater system; and
again introducing one or more of the carbonaceous gas and/or the carbonaceous material to the interior of the shaft furnace and again reducing the iron oxide using the heated hydrogen rich reducing gas in the presence of the one or more of the carbonaceous gas and/or the carbonaceous material to produce the direct reduced iron containing carbon.

18. The method of claim 17, wherein the offgas temperature from the electric gas heating unit is higher than 850° C., while the carbon deposits on the electric heating element is removed with the hydrogen.

19. The method of claim 17, wherein the offgas temperature from the electric gas heating unit is higher than 1000° C., while the carbon deposits on the electric heating element is removed with the hydrogen.

20. The method of claim 17, wherein the electric heater system utilizes a direct heating mechanism incorporating the at least one electric heating element.

21. The method of claim 17, wherein the hydrogen rich reducing gas comprises the top gas recycled from a shaft furnace and make-up hydrogen derived from an external source.
